(19) United States
(12) Patent Application Publication
(10) Pub. No.: US 2004/0061667 A1
(43) Pub. Date: Apr. 1, 2004

(54) Image sending apparatus

(76) Inventor: Tetsuya Sawano, Asaka-shi (JP)

Correspondence Address: BIRCH STEWART KOLASCH & BIRCH, PO BOX 747, FALLS CHURCH, VA, 22040-0747, US

(21) Appl. No.: 10/669,572

(22) Filed: Sep. 25, 2003

(30) Foreign Application Priority Data
Sep. 27, 2002 (JP) 2002-283267

(51) Int. Cl. G09G 3/00

(52) U.S. Cl. 345/30

(57) ABSTRACT

The image sending apparatus comprises a device which causes a desired movie file to be specified, a device which creates a general-purpose animation image file from the specified movie file, and a device which sends the animation image file. The image sending apparatus is capable of forming and sending images similar to a movie so that even an ordinary portable terminal or the like containing no chip for processing movie data can easily receive movies.

### BACKGROUND OF THE INVENTION

1. Field of the Invention

The present invention relates to an image sending apparatus, and in particular, to an image sending apparatus capable of creating an animation image file from a movie file and sending it.

2. Description of the Related Art

In recent years, portable terminals such as a portable telephone, a PHS and so on are in widespread use. Among the portable terminals, there is a product equipped with a digital camera and capable of sending and receiving a shot image together with character information or voice information. In the case of such a portable terminal equipped with a camera, it is a general practice to operate a predetermined button and so on for taking an image and store data of the taken image as an image library in a memory. (local folder) of the portable terminal, and thereafter send a mail and so on with the data of the taken image as an attached file.

Some portable terminals with a camera have a function of sending and receiving pictures by displaying successive static images (e.g., in format of animation GIF, Multiple-image Network Graphics (MNG), etc.). Moreover, various technologies have been proposed to enable sending a movie (refer to Japanese Patent Application Publication Nos. 10-285565 and 2000-312360, for example).

However, a type of a portable terminal capable of receiving such a movie which is sent is usually limited to the portable terminal containing a chip adapted for processing movie data. The movie data is usually compressed temporally and spatially in many cases (e.g., in format of MPEG 2, MPEG 4, etc.), and a dedicated chip is needed for processing the movie data because a burden on a CPU for reproducing the movie is significant.

Nevertheless, there are only a limited number of the portable terminals containing such chips for processing movie data at present, and the portable terminals of most users cannot receive movies.

### SUMMARY OF THE INVENTION

The present invention has been made in view of such circumstances. Its object is to provide an image sending apparatus capable of forming and sending the images similar to the movie so that even an ordinary portable terminal or the like containing no chip for processing movie data can easily receive the pseudo movie.

In order to attain the above-described object, the present invention is directed to an image sending apparatus, comprising: a device which causes a desired movie file to be specified; a device which creates a general-purpose animation image file from the specified movie file; and a device which sends the animation image file.

According to the present invention, a general-purpose animation image file is created from the specified movie file and the images similar to the movie can be transmitted. Therefore, it is possible to receive the images similar to the movie even on the portable terminal or the like without special configuration such as chips for processing movie data so as to broadly satisfy user requirements.

“Animation images” herein include not only the animation images such as cell-animation, CG animation and so on projected or televised in a cinema or on TV but also pseudo movie wherein they become moving images by successively displaying a plurality of static images.

Preferably, the image sending apparatus further comprises a device which causes a reproduction range of the specified movie file to be specified. According to the present invention, the image sending apparatus can conveniently send only a necessary range of the movie file.

Preferably, the image sending apparatus further comprises a communication device capable of two-way communication with a portable terminal. According to the present invention, the image sending apparatus can send the images similar to the movie to the portable terminals according to requests from a portable telephone, a PHS and so on so as to broadly satisfy the user requirements.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a conceptual diagram of a communication system including an image sending apparatus related to the present invention;

FIG. 2 is an example of a display screen of a display portion of a portable terminal with a camera;

FIG. 3 is a flowchart showing a device which creates an animation image;

FIG. 4 is a conceptual diagram explaining a relationship between a static image and the animation image;

FIG. 5 is a conceptual diagram showing a flow of animation image creation on the portable terminal with a camera; and

FIG. 6 is a conceptual diagram explaining a relationship between the static image and the animation image.

### DETAILED DESCRIPTION OF THE PREFERRED EMBODIMENTS

Hereafter, preferred embodiments of an image sending apparatus according to the present invention will be described with reference to the attached drawings.

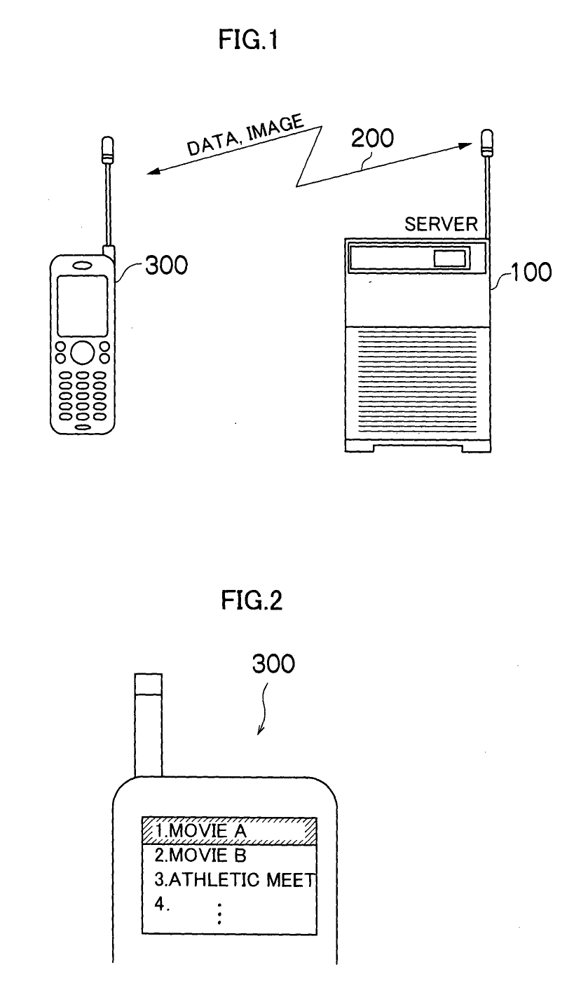

FIG. 1 is a conceptual diagram of a communication system to which an image sending apparatus according to the present invention is applied including a portable terminal. As shown in the drawing, this communication system is a system capable of sending and receiving an image between a server 100 which is an image sending apparatus according to the present invention and a portable terminal 300. A general computer system having a communication device capable of two-way communication is applicable as for the server 100, and a description of its hardware and so on will be omitted. An image memory of the server 100 can record a plurality of image files.

The portable terminal 300 is a next generation portable telephone of a Wireless Access method such as W-CDMA (Wideband Code Division Multiple Access) or CDMA2000. The two-way communication of data and images is carried out through a portable telephone network 200.

A description will be given as to operation of the communication system such as the server 100 constituted as above. FIG. 2 shows an example of a display screen of the portable terminal 300. Each image file recorded on the server 100 is displayed on this display screen. Of the image files, the files indicated as “1. Movie A” and “2. Movie B” are movie files compressed by MPEG2 and so on. The movie files from “3. Athletic meet” and thereafter are the movie files of digital video and so on.

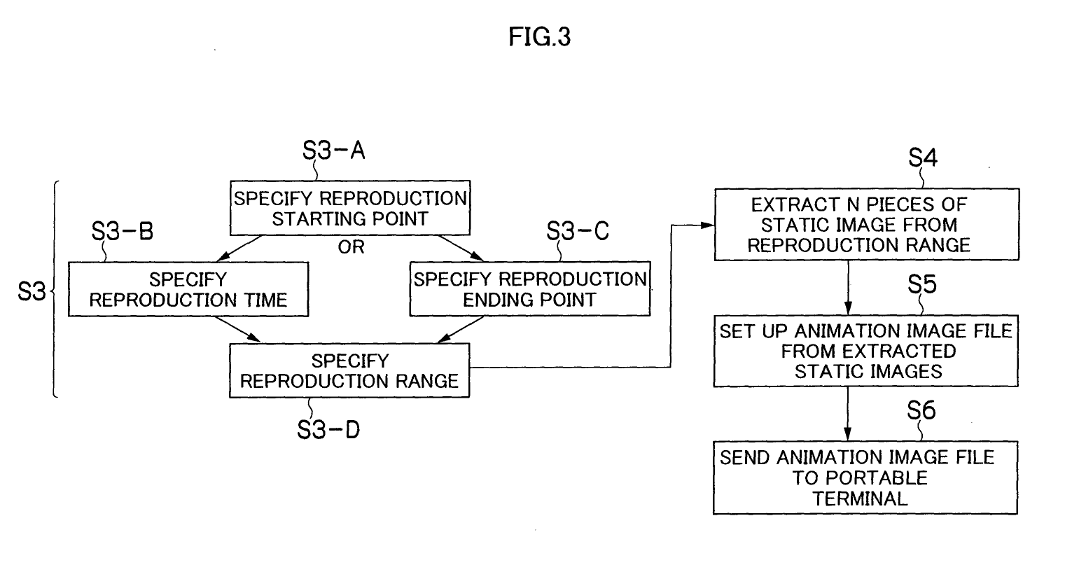

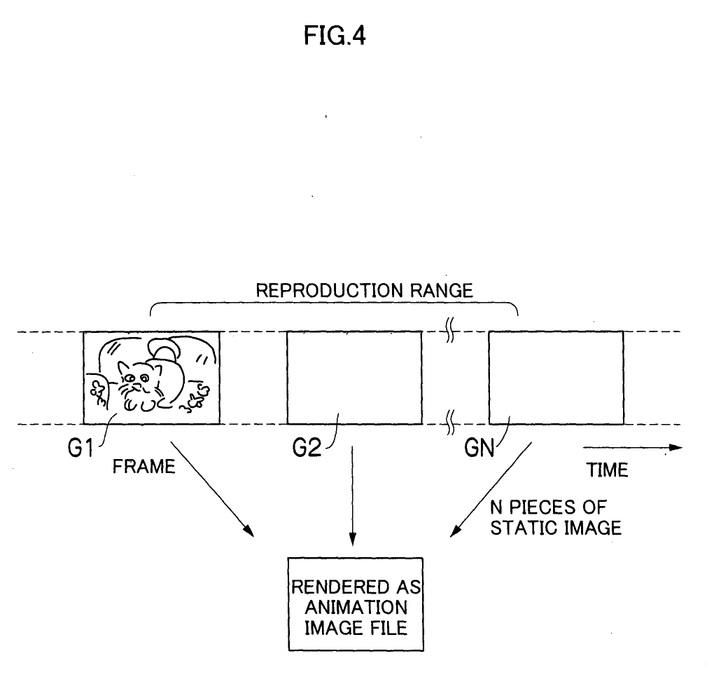

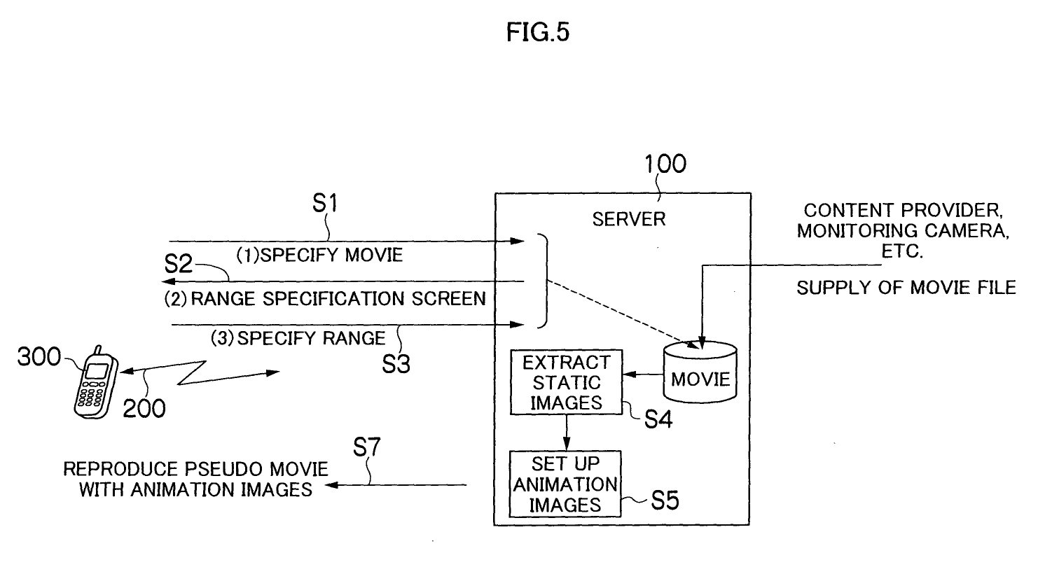

Here, a description will be given, for instance, as to the operation of selecting the movie file of “3. Athletic meet,” creating an animation image file and sending it. FIG. 3 is a flowchart showing processing for creating the animation image file. FIG. 4 is a conceptual diagram explaining a relationship between the movie and the animation images. FIG. 5 is a conceptual diagram showing a flow of animation image creation on the server 100.

In FIG. 5, a plurality of image files are recorded in the image memory of the server 100. These image files are supplied from a content provider, a monitoring camera, a digital camera and so on.

First, a file of the image for which the animation images should be created is selected on the display screen of the portable terminal 300 illustrated in FIG. 2 (step S1 in FIG. 5). When the file of the image to be selected is determined by key operation of the portable terminal 300, the selection is sent to the server 100. On reception the selection, the server 100 prompts the portable terminal 300 by transmission to do input to specify the portion to be used as the animation images of the selected image file. Then, the portable terminal 300 has a reproduction range specification screen displayed thereon (step S2). When a reproduction range is then specified on the reproduction range specification screen (step S3) and is determined, the contents are sent to the server 100.

Details of the step S3 are shown in the flowchart in FIG. 3. In FIG. 3, a reproduction starting point is specified first (step S3-A). A leading image to be the reproduction starting point is corresponding to a frame image G1 in FIG. 4. Next, reproduction time is specified (step S3-B), or a reproduction ending point is specified (step S3-C). Thus, the reproduction range is specified (step S3-D). N pieces of static image are specified in the shown example.

The static images of which reproduction range is determined are extracted from a static image file (step S4), and are set up as the animation images (step S5). The animation images can be in a format of animation GIF, MNG and so on as publicly known.

In this case, the animation images are rendered as a file (rendered as an animation image file) as shown in FIG. 4, and is once stored as the animation image file in the image memory or is immediately sent to the portable terminal (step S6). The animation image file stored in the image memory is sent according to a request from the portable terminal 300, and can be displayed and checked on the display of the portable terminal 300 (step S7).

When rendering the animation images as a file as shown in FIG. 4, it may be arbitrarily set up as to how many frames of the static images should be extracted each time according to shooting frequency of the images (how many frames per second), moving speed of the object, display speed of the animation (how many frames per second) and so on.

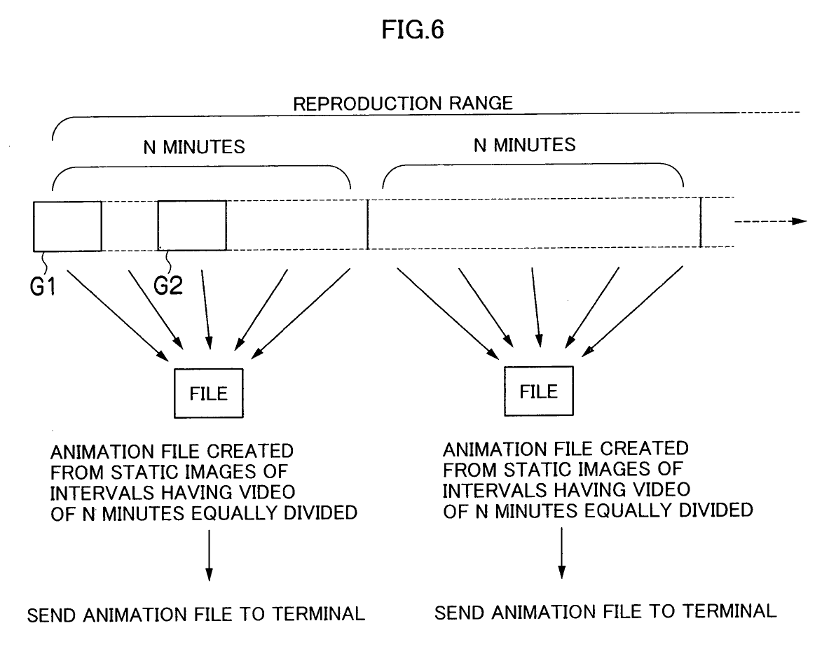

As shown in FIG. 6, it is also possible to adopt a method whereby, of the movie file, static image groups per predetermined time (N minutes in the shown example) are extracted to be rendered as a plurality of animation image files, to be stored in the image memory or immediately sent to the portable terminal.

The present invention is not limited to the above-described embodiment but may adopt various forms. For instance, the above-described embodiment concerns to the system capable of sending and receiving the images between the server 100 and the portable terminal 300. It is also possible, however, to adopt the portable terminal of the same specifications as the portable terminal 300 instead of the server 100 which is the image sending apparatus. To be more specific, it is the form in which the portable terminals 300 having the image memory mutually send and receive the animation images. In this case, both the sending side and receiving side have a voice sending and receiving device and an image sending and receiving device so that it is convenient for the users.

In the above-described embodiment, the movie file of the image files of the server 100 is specified by the transmission from the portable terminal 300. It is also possible for instance, however, to have configuration wherein the movie file is specified by manual input from operation devices (a keyboard and a display for instance) on the server 100 side.

The receiving side does not necessarily have to be the portable terminal such as the portable telephone but may be any terminal having the image receiving device.

As described above, according to the present invention, it is possible to create the animation images from the specified movie file and thereby send the images similar to the movie. Therefore, it is possible to receive the images similar to the movie even on the portable terminal or the like having no special configuration such as the chip for processing the movie data so as to broadly satisfy user requirements.

It should be understood, however, that there is no intention to limit the invention to the specific forms disclosed, but on the contrary, the invention is to cover all modifications, alternate constructions and equivalents falling within the spirit and scope of the invention as expressed in the appended claims.

At is claimed is:

1. An image sending apparatus, comprising:
a device which causes a desired movie file to be specified;
a device which creates a general-purpose animation image file from the specified movie file; and
a device which sends the animation image file.

2. The image sending apparatus as defined in claim 1, further comprising a communication device capable of two-way communication with a portable terminal.

3. The image sending apparatus as defined in claim 1, further comprising a device which causes a reproduction range of the specified movie file to be specified.

4. The image sending apparatus as defined in claim 3, further comprising a communication device capable of two-way communication with a portable terminal.
